(19) United States
(12) Patent Application Publication
(10) Pub. No.: US 2009/0179493 A1
(43) Pub. Date: Jul. 16, 2009

(54) Power selection system for heater

(76) Inventor: Ming-Hsiang Yeh, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,601

(22) Filed: Jan. 14, 2008

(51) Int. Cl. H02J 9/00

(52) U.S. Cl. 307/64

(57) ABSTRACT

A power selection system is provided for a heater system, including a power selection device, an interface unit, and a heater. The power selection device includes a distribution selector and an uninterrupted power supply device. The distribution selector is arranged inside the uninterrupted power supply device. The distribution selector controls selection of power input of the power selection device among multiple power sources. The interface unit is connected to the power selection device. The heater includes a power system, which is connected to the interface unit. As such, the system, as a whole, can be arranged in accordance with the user's need to receive a power input or a combination of multiple power inputs selected from multiple power sources in different periods of time and is fit for heaters of different brands available in the market.

### FIELD OF THE INVENTION

The present invention relates to a power selection system specific for a heater, and in particular to a system comprising a combination of a power selection device, an interface unit and a heater, wherein the power selection device comprises a distribution selector for receiving and selecting an input among multiple power sources, including both alternate-current (AC) power sources and direct-current (DC) power source, to supply a selectively combined power to the heater to thereby feature multiple selections of power input, so as to be applicable to private and public places, such as home, office, and markets, to serve as air heating facility thereof.

### BACKGROUND OF THE INVENTION

Due to the greenhouse effect caused by global warming, the variation of temperature all over the world is getting more and more significant. Consequently, the winter time becomes extremely cold, making people constantly feeling cold in their extremities in the winter and their movement getting slow. If warm keeping fails, people get hypothermia, leading to danger to their lives. Under this condition, a heater becomes vitally important. A conventional heater of any kind, such as a heating/cooling air conditioning device, a ceramic heater, a halogen heater, an infrared heater, is powered by the electrical main. However, with the change of the philosophy of power consumption, various substitute and sustainable power sources are now being proposed, including hydraulic power generation, wind power generation, solar power generation and fuel cells. Almost every country in the world encourages the development and use of the substitute and sustainable power sources by providing various rewards and incentives. Apparently, the electric main is no longer an idea power source to suit the need of the future heater market.

In view of the above problems, the present invention is aimed to provide a power selection system specific for a heater that allows the heater to be operated with a power source or a combination of multiple power sources selected from various ones by taking into consideration of the most economically efficient in accordance with beneficial energy policy of local governments in order to overcome the above problems.

### SUMMARY OF THE INVENTION

An objective of the present invention is to provide a power selection system for a heater, which features a combination of a power selection device, an interface unit, and a heater, wherein the power selection device comprises a selection distributor that controls selection of power inputs, which can be either direct-current (DC) power sources or alternate-current (AC) power sources so that power supplied to the heater is from a different power source or a combination of multiple power sources selected from various power sources in different periods of time in accordance with preset arrangement done by a user to there enhance the practicability of the present invention.

Another objective of the present invention is to provide a power selection system for a heater, which features a combination of a power selection device, an interface unit, and a heater, wherein the interface unit comprises electrical receptacles formed in accordance with power systems of various heaters so that the power selection system of the present invention is fit for heaters of various brands available in the market to thereby enhance the convenience of the present invention.

To realize the above objective, in accordance with the present invention, a power selection system is provided for a heater system, comprising a power selection device, an interface unit, and a heater. The power selection device comprises a distribution selector and an uninterrupted power supply device. The distribution selector is arranged inside the uninterrupted power supply device. The distribution selector controls selection of power input of the power selection device among multiple power sources. The interface unit is connected to the power selection device. The heater comprises a power system, which is connected to the interface unit. As such, the system, as a whole, can be arranged in accordance with the user's need to receive a power input or a combination of multiple power inputs selected from multiple power sources in different periods of time and is fit for heaters of different brands available in the market.

### BRIEF DESCRIPTION OF THE DRAWINGS

The present invention will be apparent to those skilled in the art by reading the following description of a preferred embodiment thereof with reference to the drawings, in which:

FIG. 1 is a schematic block diagram of a power selection system in accordance with the present invention that is applied to a heater;

FIG. 2 is a schematic block diagram illustrating connection between a power selection device and an interface unit of the power selection system in accordance with the present invention;

FIG. 3 is a detailed block diagram of a distribution selector of the power selection device of the present invention; and

FIG. 4 is a schematic view showing the connection of the power selection system of the present invention to various power sources and a heater.

### DETAILED DESCRIPTION OF THE PREFERRED EMBODIMENT

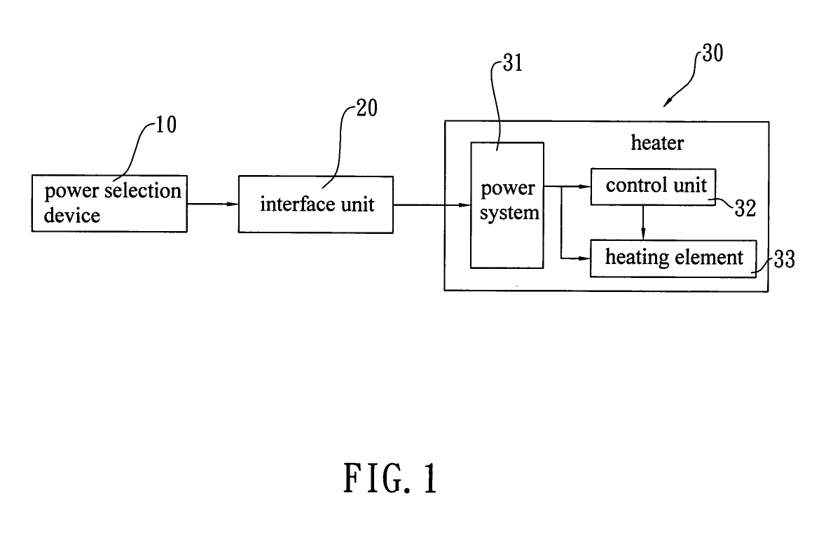

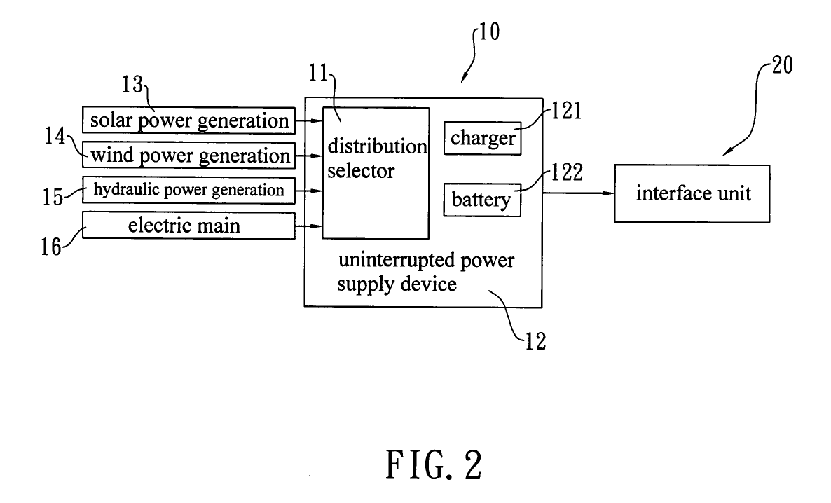

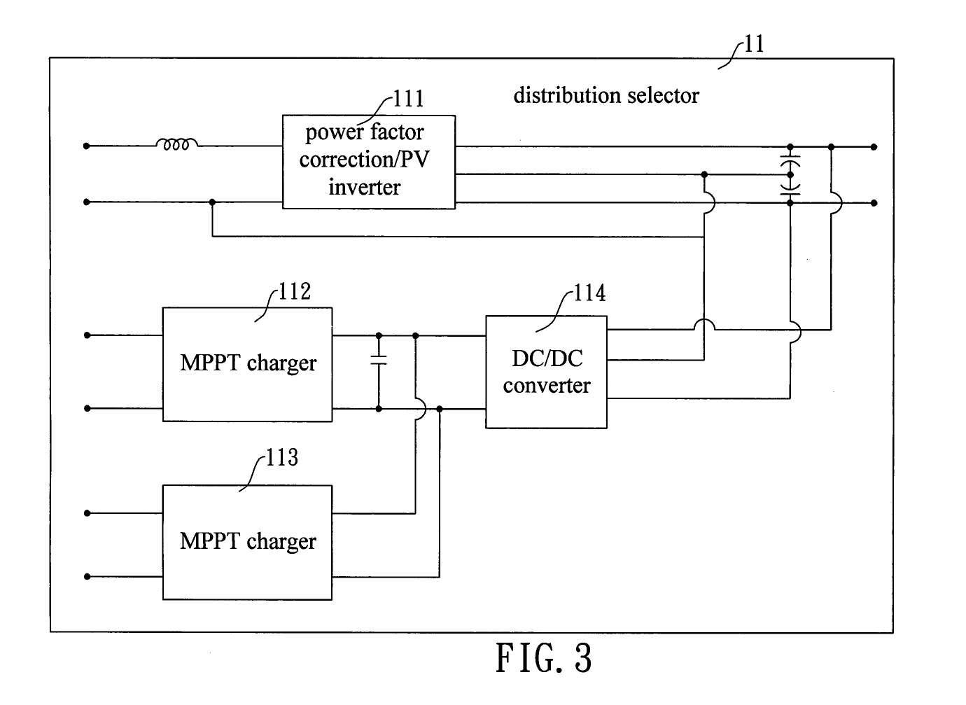

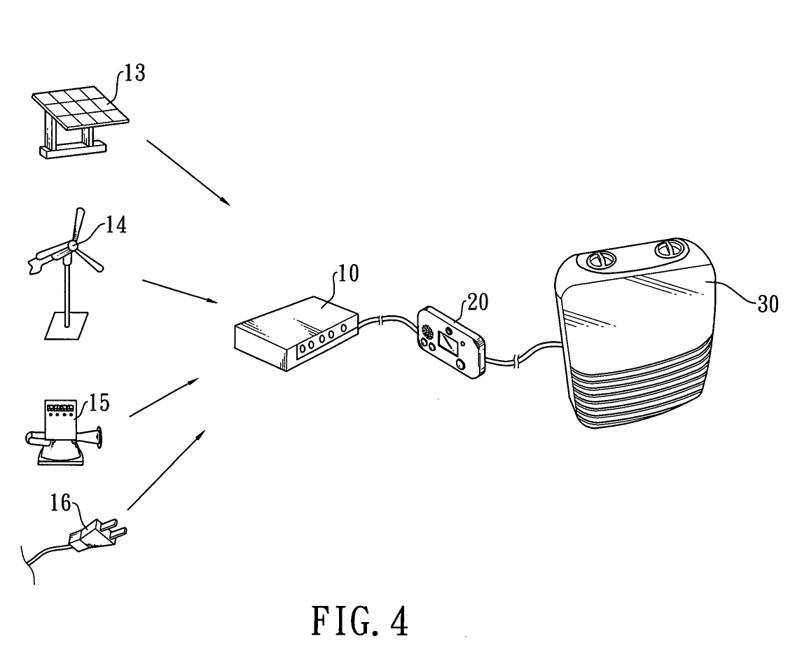

With reference to the drawings and in particular to FIGS. 1-4, the present invention provides a power selection system specifically for a heater. The power selection device comprises a power selection device, generally designated at 10, which comprises a distribution selector 11 and an uninterrupted power supply device 12. The distribution selector 11 is arranged inside the uninterrupted power supply device 12 and functions to selectively receive inputs of both direct-current (DC) power and alternate-current (AC) power, which can be at least one of a plurality of power sources including for example solar power generation 13, wind power generation 14, hydraulic power generation 15, and an electric main 16, for proper distribution of the input power supply among these power sources to realize diversification of supply of power. The distribution selector 11 is comprised of a plurality of capacitors, an inductor, a power factor correction/PV (photovoltaic) inverter 111, two MPPT (Maximum Power Point Tracking) chargers 112, 113, and a DC/DC converter 114. Each MPPT charger 112, 113 is connected to the DC/DC converter 114, which is connected in parallel to the power factor correction/PV inverter 111. The uninterrupted power supply device 12 comprises a charger 121 and a battery 122.

An interface unit 20, which in a preferred embodiment, comprises an electrical receptacle, has an end connected to the uninterrupted power supply device 12 of the power selection device 10 and an opposite end serving as an output terminal that supplies DC or AC power.

A heater 30 comprises a power system 31, a control unit 32, and a heating element 33. The power system 31 is connected to the interface unit 20 for supplying power to the power system 31 of the heater 30. The power system 31 functions to supply and distribute power to the control unit 32 and the heating element 33. The control unit 32 is connected to the heating element 33 to control the conversion of electrical power into thermal power by the heating element 33 for the generation of warm/heated air.

Referring to FIGS. 1-4, the power selection system in accordance with the present invention is provided specific for a heater and features that the distribution selector 11 of the power selection device 10 receives both DC and AC power inputs and the interface unit 20 is connected with the power system 31 of the heater 30 so that when the heater 30 is activated, the distribution selector 11 performs control to have the heater 30 first started by using the electrical main 16 as a priority power source and subsequently, after the heater 30 reaches a normal and stable operation or simply due to economic power management consideration (such as discounted off-peak utility charge or government sponsored substitute power resources), the distribution selector 11 makes the heater 30 powered by a second priority DC power, such as solar power generation 13, as a supplemental power source. In condition of insufficiency of power supply based on the above arrangement, a third priority power source, such as wind power generation 14, can be supplemented to the heater 30. Alternatively, the management of power supplied to the heater can be done so that in a specific period of time or date or under certain predefined conditions, all the power sources base on a given priority or a given distribution ratio to supply power to the heater in order to ensure optimum efficiency of power supply. (For example, a power input that is a combination of 80% DC power provided by the solar power generation 13 and 20% AC power supplied from the electric main 16 can be taken for the heater to realize diversification of power supply, or any other distributed combination of any other power inputs cab be used.)

Further, the distribution selector 11 can be programmed by means of either software, or hardware or both on the basis of a user's need so that regardless of the primary power source being shut down or not, the system of the present invention can search for a second priority power source, as well as other power generation systems that can serve as power sources, and, based on the programming conditions set by the user, sets the ratios of powers supplied from the selected power sources and the time period to receive the power from each power source. Moreover, the interface unit 20 can be embodied as electrical receptacle of different forms or specifications to mate the power systems 31 of different heaters 30 available in the market so that the power selection device 10 is fit for the power systems 31 of heaters 30 of various brands.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A power selection system for use with a heater and comprising:
a power selection device comprising a distribution selector and an uninterrupted power supply device, the distribution selector being arranged inside the uninterrupted power supply device, the distribution selector controlling selection of power input of the power selection device among multiple power sources;
an interface unit connected to the power selection device; and
a heater comprising a power system, which is connected to the interface unit.

2. The power selection system as claimed in claim 1, wherein the distribution selector selectively receives inputs of direct-current (DC) power and alternate-current (AC) power.

3. The power selection system as claimed in claim 2, wherein the power input is obtained from various power sources comprising at least solar power generation, wind power generation, hydraulic power generation, and an electric main, of which at least one or a combination of more than one is selected as the power input to diversify supplying of power.

4. The power selection system as claimed in claim 1, wherein the interface unit has an output that selectively supplies DC power or AC power.

5. The power selection system as claimed in claim 1, wherein the interface unit comprises an electrical receptacle.

6. The power selection system as claimed in claim 1, wherein the heater comprises a power system, a control unit, and a heating element, the power system supplying power to the control unit and the heating element, and wherein the control unit is connected to and controls the heating element to convert the power into heat for generation of warm air.

7. The power selection system as claimed in claim 1, wherein the distribution selector comprises a power factor correction/PV (photovoltaic) inverter, at least one MPPT (Maximum Power Point Tracking) chargers, and a DC/DC converter, the MPPT charger being connected to the DC/DC converter, which is connected in parallel to the power factor correction/PV inverter.

8. The power selection system as claimed in claim 1, wherein the uninterrupted power supply device comprises a charger and a battery.
